(19) United States
(12) Patent Application Publication
(10) Pub. No.: US 2024/0019115 A1
(43) Pub. Date: Jan. 18, 2024

(54) BATHROOM MIRROR WITH LIGHTING FUNCTION

(71) Applicant: NINGBO GANPE OPTOELECTRONICS CO., LTD., NINGBO (CN)

(72) Inventor: Guangrong XU, Ningbo City (CN)

(21) Appl. No.: 18/334,929

(22) Filed: Jun. 14, 2023

(51) Int. Cl. F21V 33/00; F21V 23/02; F21V 23/04

(52) U.S. Cl. CPC F21V 33/004; F21V 23/023; F21V 23/0471; A47G 1/00

(57) ABSTRACT

The disclosure provides a bathroom mirror with a lighting function. A light-emitting member is arranged on the mirror body for providing the lighting. A power supply assembly supplies power to avoid wiring requirements during mounting. A battery pack of the power supply assembly is a removable rechargeable battery, such that plugging and unplugging the battery pack are not blocked. When being mounted, the bathroom mirror only needs to be fixed at an appropriate position on the wall according to use requirements. The battery pack can also be easily taken out from the side of the mirror body.

### TECHNICAL FIELD

The disclosure pertains to the field of bathroom mirror, and specifically pertains to a bathroom mirror with a lighting function.

### BACKGROUND

A bathroom mirror is defined as the mirror placed in a bathroom for people to freshen up. It is an indispensable constituent of the bathroom space. Clear and bright bathroom mirror bring people a good mood when dressing up.

When ambient light is relatively dark, it is difficult to see an image in a mirror, and the mirror is inconvenient to use. To this end, some bathroom mirrors are equipped with light sources, which make the bathroom mirrors more beautiful and practical. After a bathroom mirror is mounted, its light source is directly connected to an external power supply, and the light source is controlled through a manual switch or a sensor switch. The light source is powered by the mains power supply, and it is necessary to reserve a wire end for the light source in advance. Moreover, the light source cannot be used in case of power failure, therefore, the bathroom mirror is not flexible enough to use, and is also inconvenient to move.

### SUMMARY

In order to overcome the above defects in the prior art, the disclosure provides a bathroom mirror with a lighting function.

According to the bathroom mirror with a lighting function of the disclosure, a light-emitting member is arranged on the mirror body for lighting. A power supply assembly supplies power to avoid wiring requirements during mounting. A battery pack of the power supply assembly is a removable rechargeable battery, such that plugging and unplugging of the battery pack are not blocked. When being mounted, the bathroom mirror only needs to be fixed at an appropriate position on the wall according to use requirements. The battery pack can also be easily taken out from the side of the mirror body for recharging or replacement.

In a preferred embodiment of the disclosure, the power supply assembly includes a lighting switch for controlling the lighting assembly to be turned on and off and a microwave sensor switch, the lighting switch can turn on or turn off the lighting assembly, and the microwave sensor switch can turn off the lighting assembly with a delay after a user leaves the mirror body when the lighting assembly is in the “ON” state. In such a way, it can prevent the battery pack from being drained due to lighting after a user leaves from the mirror. Meanwhile, the microwave sensor switch is only used to sense to turn off, rather than turn on, the lighting, thereby saving power, so that the battery can provide lighting for a longer period of time.

In the bathroom mirror with a lighting function of the disclosure, the power supply assembly and the mirror body structure can be used separately, so as to make them exert their own functions.

### BRIEF DESCRIPTION OF THE DRAWINGS

FIG. 1 is a schematic diagram of a back structure of a bathroom mirror of an embodiment of the disclosure, where a mirror body 1 is in the shape of a right-angled rectangle;

FIG. 2 is a schematic diagram of a front structure of a bathroom mirror of another embodiment of the disclosure, where a mirror body 1 is in the shape of a rounded-angled rectangle and a light-transmitting area 18 is arranged on the lower right side of the front of the mirror body 1;

FIG. 3 is a schematic diagram of a back structure of a bathroom mirror of another embodiment of the disclosure, which is similar to the embodiment illustrated in FIG. 1 on the whole, but which adopts a supporting block 17 to replace a supporting frame body 19 in the embodiment illustrated in FIG. 1 for supporting;

FIG. 4 is a structural schematic diagram of a side view of a side near the power supply assembly 200 in the embodiment illustrated in FIG. 3, where a cabling pipe 16 is removed;

FIG. 5 is an enlarged diagram at a portion A in FIG. 4;

FIG. 6 is an exploded view of a structure of a power supply assembly 200 in the embodiments illustrated in FIGS. 1-3;

FIG. 7 is a schematic diagram of the operation of a battery pack in an embodiment of the disclosure, where the battery pack 202 is pressed and pops out for a user to take out for recharging or replacement;

FIG. 8 is a schematic diagram of the operation of a battery pack in another embodiment of the disclosure, where the battery pack 202 is pushed by the chamber cap 205 capable of sliding up and down to be assembled inside the receiving chamber 204 or pop out after the chamber cap 205 slides away for the use to take out for recharging or replacement; and

FIG. 9 is a schematic diagram of the operation of a battery pack in another embodiment of the disclosure, where the chamber cap 205 is a removable structure for the user to plug in and unplug out of the battery pack 202 after the chamber cap 205 is removed.

In the accompanying drawings: mirror body 1, light-transmitting member 2, mounting shell 3, accommodating cavity 31, opening 32, hanging portion 33, light-transmitting side plate 4, light source 7, first slot 8, second slot 9, port cap 12, protrusion 13, mounting hole 14, cabling pipe 16, supporting block 17, light-transmitting area 18, supporting frame body 19, power supply assembly 200, housing 201, battery pack 202, chamber opening 203, receiving chamber 204, chamber cap 205, elastic member 206, arc-shaped handle 207, positioning plate 208, guide rail 209, slide rail 210, protruding piece 211, main board 212, power interface 213, socket 214, and lighting switch 215.

### DESCRIPTION OF THE EMBODIMENTS

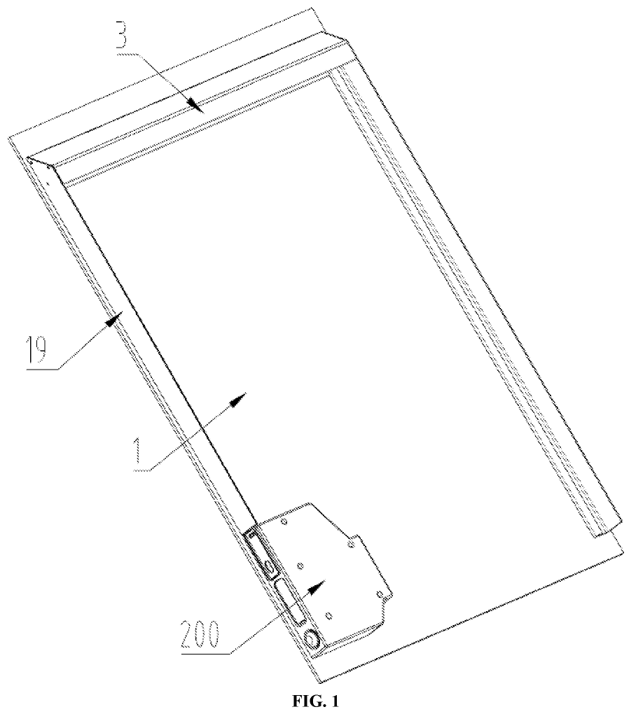

The embodiments of the disclosure will be described in detail below in conjunction with FIGS. 1-9.

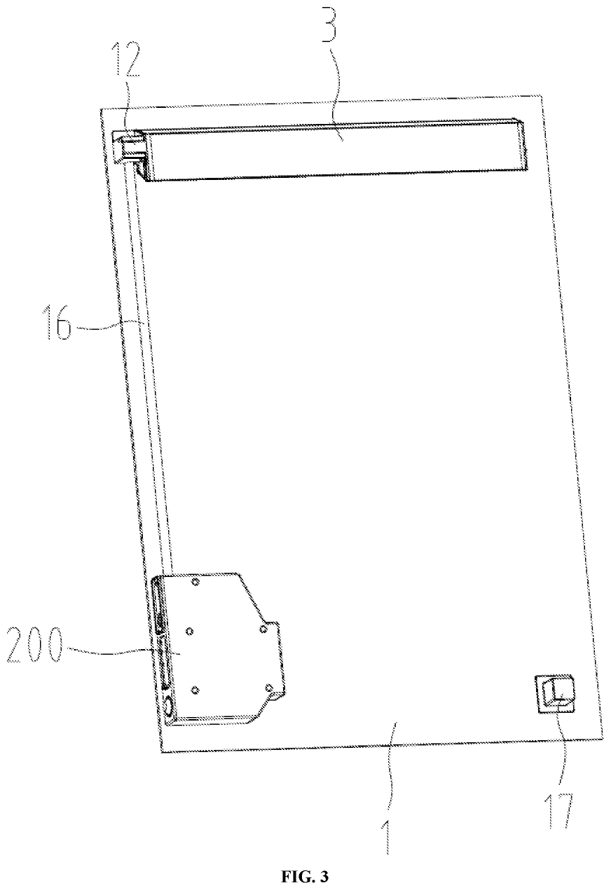

In an embodiment, as shown in FIGS. 3-5, a bathroom mirror with a lighting function includes a mirror body 1, and a light-transmitting member 2 arranged at the upper part of the front of the mirror body 1, where the light-transmitting member 2 can be a hole body formed by opening a hole on the mirror body 1, or a transparent hole formed by not coating a reflective layer locally on the mirror body 1, a mounting shell 3 is arranged at the corresponding position on the back of the mirror body 1 to correspond to the light-transmitting member 2, the mounting shell 3 has an accommodating cavity 31, a lighting assembly (such as an LED lamp group) is arranged inside the accommodating cavity 31, an opening 32 of the accommodating cavity 31 faces towards the light-transmitting member 2, so that light emitted by the lighting assembly passes through the opening 32 and then passes through the light-transmitting member 2, and a hanging portion 33 is arranged continuously or at intervals on the outer edge of the bottom of the mounting shell 3 in a length direction of the mounting shell 3.

In this embodiment, the mounting shell 3 is an “a-shaped” frame body and arranged in a length direction of the light-transmitting member 2, the opening 32 of the mounting shell 3 faces towards the light-transmitting member 2, an bent edge of the opening 32 of the mounting shell 3 is attached and fixed to the mirror body 1 in a face-to-face form, so as to complete the fixed connection between the mounting shell 3 and the mirror body 1. The mounting shell and the mirror body can be fixed by means of bonding, gluing or hot melting. Different from a fastener connection, such means of connection can ensure the sealing of the mounting shell 3 to a certain extent. The hanging portion 33 extends downwards from the side of the mounting shell 3 facing the wall, so that the hanging portion 33 is flush with the side of the mounting shell 3 against the wall, forming a flat surface against the wall, and the mirror body 1 can be hung stably on the wall.

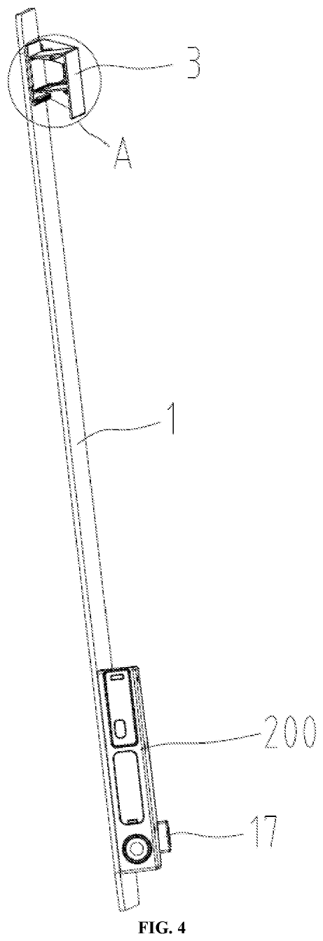

As shown in FIG. 5, the lighting assembly includes a light-transmitting side plate 4 and a light source 7, a first slot 8 is formed on the inner wall of the opening 32 of the accommodating cavity 31, the first slot 8 is arranged on the upper and lower sides of the opening 32, the first slot 8 is arranged in the length direction of the mounting shell 3, the light-transmitting side plate 4 is inserted into the first slot 8, so that the upper and lower sides of the first slot 8 respectively accommodate two ends of the light-transmitting side plate 4, and the light-transmitting side plate 4 after being inserted is parallel to the light-transmitting member 2. Surely, it is also feasible to use the light source 7 only as the lighting assembly without providing the light-transmitting side plate 4.

A second slot 9 is formed on the inner wall of the accommodating cavity 31 away from the light-transmitting side plate 4, the second slot 9 is located in the middle of the inner wall of the accommodating cavity 31, the light source 7 is mainly an LED lamp strip, the LED lamp strip is inserted into the second slot 9 in a direction same as that of the light-transmitting side plate 4, and LED lamp beads on the LED lamp strip face towards the light-transmitting side plate 4, so that light emitted by the light source 7 can be transmitted from the light-transmitting side plate 4. The insertion mounting method features simple structure, and convenient to assemble and disassemble the lighting assembly (capable of being directly inserted through the end of the mounting shell 3), without additional connectors or fasteners.

Two ends of the mounting shell 3 are each provided with a port, port caps 12 are arranged on the ports, a protrusion 13 flushing with the ends of the mounting shell 3 is formed in a length direction of the inner wall of the mounting shell 3, a mounting hole 14 is formed on the end face of the protrusion 13 flushing with the ends of the mounting shell 3, the mounting hole 14 is usually a screw hole, and a fastener is mounted in the screw hole, so that the port caps 12 are fixedly connected with the mounting hole 14 through the fasteners.

The protrusion 13, as a screw hole column, can be extended to another port in the length direction of the mounting shell 3, so that the protrusion 13 can be not only used to connect the port caps 12, but also serve as a rib reinforcement to reinforce the strengthen of the mounting shell 3. Surely, the protrusion 13 is separately disposed at two ends in the form of cylindrical segments.

A notch is formed on one side of the protrusion 13 to form an expansion mounting hole 14 for fixed connection of the fasteners.

A power supply assembly 200 is arranged on one side of the bottom of the back of the mirror body 1. The power supply assembly 200 is electrically connected with the lighting assembly through a cable, and the cable runs along the edge of the mirror body 1 and one end thereof passes through the port caps 12 and is connected to the light source 7. In this embodiment, the power supply assembly 200 including components such as a power supply, a main board, and a switch to supply power to the lighting assembly and control the operation of the lighting assembly.

Preferably, as shown in FIG. 3, the cable is enclosed and provided with a cabling pipe 16, one end of the cabling pipe 16 is connected to the power supply assembly 200, the other end thereof passes through the port caps 12 of the mounting shell 3 and is then connected to the light source 7, and the cabling pipe 16 is used to concentrate and protect the cable.

As shown in FIG. 3, a supporting block 17 for forming a supporting member is arranged at a symmetrical position at the bottom of the back of the mirror body 1 relative to the power supply assembly 200. The supporting block 17 is in a protruding structure. The thickness of the supporting block 17, the mounting shell 3 and the power supply assembly 200 are consistent, the supporting block 17 and the power supply assembly 200 are located at both sides of the bottom of the back of the mirror body 1 respectively, and the mounting shells 3 are respectively distributed at different locations of the back of the mirror body 1, so that after being hung on a wall or a cabinet, the mirror body 1 is parallel to the wall or the cabinet, making the mirror body 1 flatter and more beautiful.

As shown in FIG. 1, in some other embodiments, in order to make the mirror body 1 after being hung on the wall or on the cabinet keep flat and stable, a supporting frame body 19 for forming a supporting member can be arranged on the back of the mirror body 1 along the edge thereof, the supporting frame body 19 may be a wide variety of flanging forming I-shaped steel or channel steel, and the like. In this embodiment, the supporting frame body 19 is distributed on both sides of the back and the top of the mirror body 1, and the thickness of the supporting frame body 19 is greater than or equals to the thickness of the mounting shell 3, so that the mounting shell 3 and the supporting frame body 19 are flush or hidden in the mirror body, without being in contact with the wall.

The above supporting frame body 19 and the supporting block 17 can be arranged both or alternatively. The supporting frame body 19 can also be used as a surround of the back of the mirror body 1 to protect the back of the mirror body 1.

Optimally, the power supply assembly 200 includes a microwave sensor switch. The microwave sensor switch is connected to the power supply assembly 200, and can be turned off with a delay after sensing no person to save power. Since the microwave sensor switch is a relatively mature technology, specific model and structural principle are not described herein. In this embodiment, the microwave sensor switch is not used to sense to turn on the lighting, but is only used to sense whether there is a user in front of the mirror body 1 to turn off the lighting with a delay. Turning on the lighting can be achieved by the user to switch on a lighting switch 215.

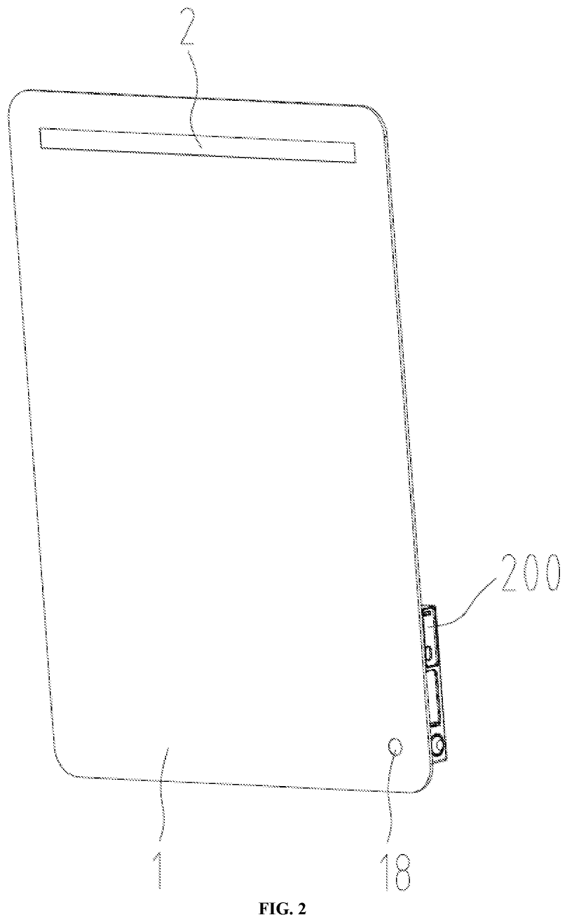

As shown in FIG. 2, a light-transmitting area 18 is arranged on the lower right side of the front of the mirror body 1, and the light-transmitting area 18 is formed by an uncoated reflective layer. The microwave sensor switch is arranged on the back side of the mirror body 1 and at the position corresponding to the light-transmitting area 18, so as to be arranged towards the front of the mirror body 1 and to detect whether a user is in front of the mirror body 1.

The microwave sensor switch is only used to detect whether the user leaves and turns off the lighting with a delay, rather than to detect whether the user is in front of the mirror body 1 and then the lighting is turned on. Turning on the lighting is implemented by the user to operate the lighting switch 215. In such a way, power consumption can be maximized, so that a battery pack 202 can provide reasonable lighting time, and the operation is relatively simple and easy to use.

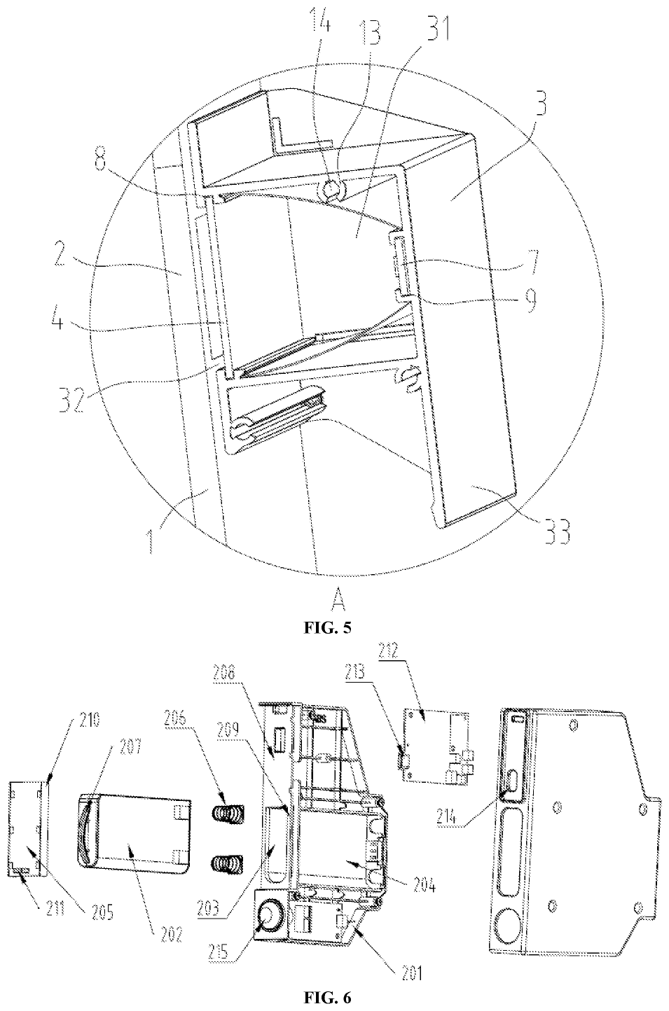

As shown in FIG. 6, the power supply assembly 200 includes a housing 201. The housing 201 is mounted on the back of the mirror body 1. A receiving chamber 204 is arranged inside the housing 201, the battery pack 202 is arranged inside the receiving chamber 204, the housing 201 is arranged on the edge close to the mirror body 1, the receiving chamber 204 with a chamber opening 203 is formed on the side of the housing 201 facing the edge of the mirror body 1, the battery pack 202 is arranged inside the receiving chamber 204 in a pluggable mode, and the battery pack 202 can be plugged into and unplugged from the receiving chamber through the chamber opening 203, such that when the mirror body 1 is hung, plugging and unplugging the battery pack 202 are not blocked, that is, plugging and unplugging the battery pack 202 can be completed from the side of the mirror body 1 after the mirror body 1 is hung, it is unnecessary to remove the mirror body 1, it is very convenient.

The battery pack 202 is a recharging storage battery, that is, a rechargeable battery. After being unplugged from the receiving chamber 204, the battery pack 202 can be recharged separately, similar to a power bank.

After being plugged into the receiving chamber 204, the interface of the battery pack 202 at its inner side is connected to a main board 212, thereby realizing electrical connection to the main board 212, so that the battery pack 202 is butted with the main board 212, while the main board 212 is electrically connected to the light source of the mirror body 1.

The power supply assembly 200 further includes the main board 212 electrically connected to the battery pack 202. The main board 212 and the battery pack 202 are arranged side by side inside the receiving chamber 204, that is, when the housing 201 is mounted at the lower left side of the back of mirror body 1, the chamber opening 203 in the housing 201 faces the lower left side of the back of the mirror body 1, the battery pack 202 and the main board 212 are distributed up and down along the height of the side of the mirror body 1, respectively, so as to ensure that the thickness of the housing 201 is minimized.

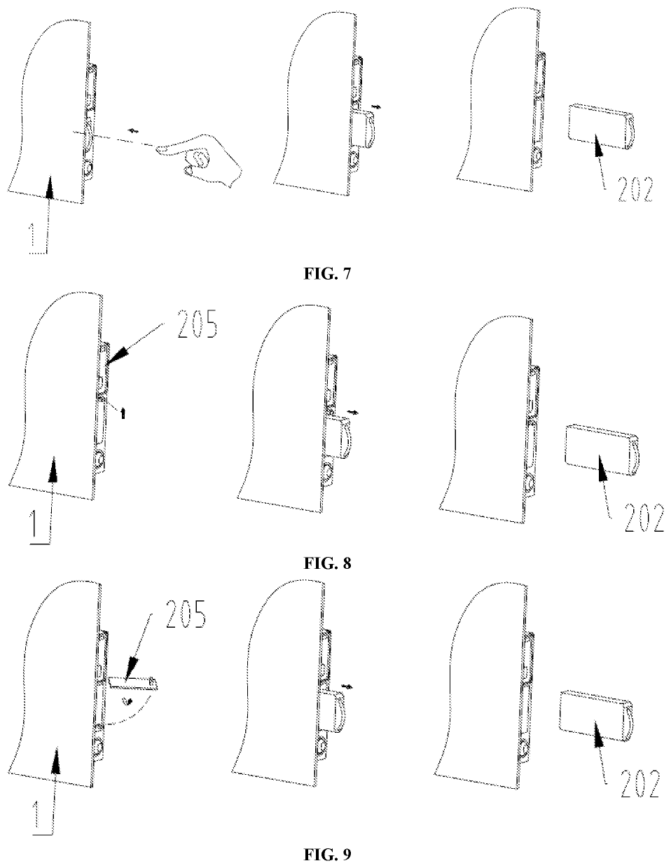

As shown in FIG. 7, in some embodiments, the battery pack 202 can be mounted inside the receiving chamber 204 by pressing and popping out of from the chamber opening 203, elastic members 206 are arranged between one end of the battery pack 202 far away from the chamber opening 203 and the inner wall of the housing 201, one end of the elastic members 206 are fixed on the inner wall of the housing 201, and the other end thereof is propped against the bottom of the battery pack 202. After being mounted inside the receiving chamber 204, the battery pack 202 compress the elastic members 206 by one end, a clamp is arranged inside the receiving chamber 204 close to the elastic members 206, and the clamp has the elastic deformation ability. A clamping groove is formed on the battery pack 202, when the battery pack 202 slides into the receiving chamber, the end of the battery pack 202 compresses the elastic members 206, at the same time, the elastic end of the clamp is stuck into the clamping groove, and the battery pack 202 is then locked in the receiving chamber. When the battery pack 202 is pressed, the clamp undergoes elastic deformation under pressure and breaks away from the clamping groove, and the battery pack 202 pop out from the opening under elastic force of the elastic members, such a mounting method is convenient for the battery pack 202 to be plugged into and unplugged from the edge of the mirror body 1.

As shown in FIG. 8, in some other embodiments, a chamber cap 205 is arranged on the chamber opening 203, and the chamber cap 205 is a chamber cap. The housing 201 is provided with a guide rail 209 at the chamber opening 203, the guide rail 209 is distributed in the length direction of the chamber opening 203, a slide rail 210 slidably matched with the guide rail 209 is arranged on the chamber cap 205, so that the chamber cap 205 is connected to the chamber opening 203 in a sliding manner to play functions of opening and closing, that is, the chamber cap 205, as a chamber cap, is connected to the chamber opening 203 in a sliding manner. The chamber cap 205 is located inside the housing 201, a protruding piece 211 extends from the surface of the chamber cap 205 facing outward. The protruding piece 211 passes through the chamber opening 203, and the protruding piece 211 is convenient for an operator to push the chamber cap 205 by hands with force. When the chamber cap 205 slides to a position where the battery pack 202 can be pulled away from the chamber opening 203, the protruding piece 211 moves together with the chamber cap 205 to one end of the chamber opening 203 and is butted with the chamber opening 203 to stop the chamber cap 205, so that the chamber cap 205 just covers. A positioning plate 208 arranged insider the housing 201 close to the chamber opening 203, the positioning plate 208 is integrated with the inner wall of the housing 201, and extends in the sliding direction of the chamber cap 205, and the guide rail 209 is located on the positioning plate 208, so that the chamber cap 205 sliding along the positioning plate 208. Since the positioning plate 208 is located at the chamber opening 203, in order to ensure a sealed environment inside the housing 201, a sealing block or a sealing ring is arranged between the positioning plate 208 and the inner wall of the housing 201, and a sealing block or a sealing ring is further arranged between the guide rail 209 and the slide rail 210, so as to prevent water vapor from entering the housing 201 from the chamber opening 203.

As shown in FIG. 9, in some other embodiments, the chamber cap 205 at the chamber opening 203 is an open cap structure. When the chamber cap 205 is stuck at the chamber opening 203, the chamber cap 205 after being disassembled from the chamber opening 203 is separated from the housing 201; or one end of the chamber cap 205 is rotationally connected to the chamber opening 203 by a pin shaft, and one end of the chamber cap 205 is flipped open and closed by the pin shaft; or the chamber cap 205 and the housing 201 are connected through a tie, so that the chamber cap is not easily lost after being separated from the mounting shell.

Therefore, the battery pack 202 of the bathroom mirror of the disclosure can be disassembled in various ways.

Further, an arc-shaped handle 207 is arranged on one end, that is, the top, of the battery pack 202 towards the chamber opening 203, and the arc-shaped handle 207 is convenient for pulling the battery pack 202.

Further, it should be noted that two elastic members 206 are provided in this embodiment, which are respectively located on both sides of the bottom of the battery pack 202. When the battery pack 202 is mounted insider the receiving chamber 204, the battery pack 202 compresses the elastic members 206, an electrically connected terminal of the battery pack 202 is propped against the corresponding electrically connected terminal of the housing 201, and the electrically connected terminal of the housing 201 is electrically connected to the main board 212, so that the battery pack 202 is electrically connected to the main board 212. When the chamber cap 205 is opened, the battery pack 202, the battery pack 202 pops out from the chamber opening 203 under the action of the restoring force of the elastic members 206, at this time, the electrically connected terminal of the battery pack 202 and the electrically connected terminal inside the housing 201 are separated, so that the battery pack 202 disconnected with the main board 212.

As shown in FIG. 6, the housing 201 is a box-type housing, it includes a bottom case and a case cover. The bottom case is detachably fixed on the back of the mirror body 1 by fasteners, the receiving chamber 204 is located on the bottom case, and the case cover is detachably fixed on the bottom case by fasteners.

The battery pack 202 is generally in the shape of a flat cuboid, that is, the thickness is as thin as possible, and so is the housing 201, so that the distance between the mirror body 1 after being hung and the wall or cabinet is as small as possible to increase the overall aesthetics. The handle is in an arc-shaped strip structure, and arranged at the central position of the side of the battery pack 202 facing the chamber opening 203, so that the operator can use two fingers to hold the handle and apply pull force.

The main board 212 has a power interface 213, and the housing 201 has a socket 214 corresponding to the power interface 213. Through the socket 214, the external power supply can be directly supplied to the mirror body 1, which is very convenient. The power interface 213 can be various USB interfaces, such as type-c, Micro USB or Lightning interface.

The positions of the socket 214 and the chamber opening 203 correspond to the positions of the main board 212 and the battery pack 202, that is, they are distributed in the length direction of a side of the housing 201, so that pulling the battery pack 202 and connecting to the external power supply do not interfere with each other.

When the power supply assembly 200 is located at the lower left side of the back of the mirror body 1, the surface where the chamber opening 203 of the housing 201 is located is flush with the side edge of the mirror body 1, or does not go beyond the side surface of the mirror body 1, so that the appearance is beautiful, and it is also convenient to operate the battery pack 202 and connect to an external power supply from the side of the mirror body 1.

At present, there are various and popular rechargeable battery packs 202 on the market. Specific structure and model of the battery pack 202 in the disclosure are subject to the actual application environment and, will not be described herein.

What is claimed is:

1. A bathroom mirror with a lighting function, comprising a mirror body (1), and a light-transmitting member (2) arranged at the front of the mirror body (1), wherein a light source arranged inside the light-transmitting member (2) to form a light-emitting member, a mounting shell (3) is arranged at the upper part of the back of the mirror body (1), the mounting shell (3) has an accommodating cavity (31), a lighting assembly is arranged inside the accommodating cavity (31), an opening (32) of the accommodating cavity (31) faces towards the light-transmitting member (2), so that light emitted by the lighting assembly passes through the opening (32) and then passes through the light-transmitting member (2), and a hanging portion (33) is arranged continuously or at intervals on the outer edge of the bottom of the mounting shell (3) in a length direction of the mounting shell (3);
a power supply assembly (200) is arranged on one side of the bottom of the back of the mirror body (1), a supporting member is arranged at the other side, and the power supply assembly (200) is electrically connected with the lighting assembly; and the power supply assembly (200), the supporting member and the mounting shell (3) are separately in close contact with the wall for supporting; and
the power supply assembly (200) comprises a housing (201) arranged at the back of the mirror body (1) and a rechargeable battery pack (202), the housing (201) is arranged near the edge of the mirror body (1), the housing (201) is provided with a receiving chamber (204), the receiving chamber (204) has a chamber opening (203), the chamber opening (203) faces the nearest edge of the mirror body (1), and the battery pack (202) is arranged inside the receiving chamber (204) in a pluggable mode, such that when the mirror body (1) is hung, plugging and unplugging the battery pack (202) are not blocked.

2. The bathroom mirror with a lighting function according to claim 1, wherein the power supply assembly (200) comprises a lighting switch (215) for controlling the lighting assembly to be turned on and off and a microwave sensor switch, the lighting switch (215) can turn on or turn off the lighting assembly, and the microwave sensor switch can turn off the lighting assembly with a delay after a user leaves the mirror body when the lighting assembly is in the “ON” state.

3. The bathroom mirror with a lighting function according to claim 2, wherein a light-transmitting area (18) with an uncoated reflective layer is arranged on the mirror body (1), the microwave sensor switch is arranged on the back side of the mirror body (1) and at the position corresponding to the light-transmitting area (18), so as to be arranged towards the front of the mirror body (1) and to detect whether a user is in front of the mirror body (1); and the supporting member is a supporting frame body (19) or a supporting block (17).

4. The bathroom mirror with a lighting function according to claim 3, wherein the battery pack (202) is mounted inside the receiving chamber (204) by pressing and popping out of from the chamber opening (203).

5. The bathroom mirror with a lighting function according to claim 3, wherein a chamber cap (205) is arranged at the chamber opening (203) in a sliding manner, and the user can plug the battery pack (202) into the receiving chamber (204) by sliding the chamber cap (205) for power supply or can make at least a portion of the battery pack (202) pop out by sliding the chamber cap (205) for take out the battery for charging or replacement.

6. The bathroom mirror with a lighting function according to claim 3, wherein the chamber cap (205) is removably arranged at the chamber opening (203), the user can plug in or unplug out of the battery pack (202) from the receiving chamber (204) after removing the chamber cap (205), and the chamber cap (205) is used to seal the receiving chamber (204).

7. A bathroom mirror with a lighting function, comprising a mirror body (1) provided with a light-emitting member, a power supply assembly (200) is arranged on the back of the mirror body (1), and the light-emitting member is formed on the front of the mirror body (1); the power supply assembly (200) comprises a housing (201) arranged at the back of the mirror body (1) and a rechargeable battery pack (202), the housing (201) is arranged near the edge of the mirror body (1), the housing (201) is provided with a receiving chamber (204), the receiving chamber (204) has a chamber opening (203), the chamber opening (203) faces the nearest edge of the mirror body (1), and the battery pack (202) is arranged inside the receiving chamber (204) in a pluggable mode, such that when the mirror body (1) is hung, plugging and unplugging the battery pack (202) are not blocked.

8. The bathroom mirror with a lighting function according to claim 7, wherein the battery pack (202) is mounted inside the receiving chamber (204) by pressing and popping out of from the chamber opening (203).

9. The bathroom mirror with a lighting function according to claim 7, wherein a chamber cap (205) is arranged at the chamber opening (203).

10. The bathroom mirror with a lighting function according to claim 9, wherein a positioning plate (208) integrated with the inner wall of the housing (201) is arranged in the chamber opening (203) of the housing (201), a guide rail (209) is arranged on the positioning plate (208), and a slide rail (210) slidably matched with the guide rail (209) is arranged on the chamber cap (205), so that the chamber cap (205) is connected with the chamber opening (203) of the housing (201) in a sliding manner.

11. The bathroom mirror with a lighting function according to claim 9, wherein the chamber cap (205) is a movable cap, and a protruding piece (211) convenient for force application is formed on the chamber cap (205).

12. The bathroom mirror with a lighting function according to claim 9, wherein the power supply assembly (200) further comprises the main board (212) electrically connected to the battery pack (202), the main board (212) has a power interface (213), and the housing (201) has a socket (214) corresponding to the power interface (213); and the socket (214) and the chamber opening (203) are distributed in the length direction of a side of the housing (201).

13. The bathroom mirror with a lighting function according to claim 9, wherein the power supply assembly (200) is located on the left and right sides of the lower half of the mirror body (1), and the surface wherein the chamber opening (203) and the socket (214) faces outwards; and a supporting frame body (19) is arranged on the back of the mirror body (1) along the edge thereof.

14. A bathroom mirror with a lighting function, comprising a mirror body (1), and a light-transmitting member (2) arranged at the front of the mirror body (1), wherein a light source arranged inside the light-transmitting member (2) to form a light-emitting member, a mounting shell (3) is arranged at a corresponding position of the back of the mirror body (1), the mounting shell (3) has an accommodating cavity (31), a lighting assembly is arranged inside the accommodating cavity (31), an opening (32) of the accommodating cavity (31) faces towards the light-transmitting member (2), so that light emitted by the lighting assembly passes through the opening (32) and then passes through the light-transmitting member (2), and a hanging portion (33) is arranged continuously or at intervals on the outer edge of the bottom of the mounting shell (3) in a length direction of the mounting shell (3).

15. The bathroom mirror with a lighting function according to claim 14, wherein the mounting shell (3) is an “a-shaped” frame body, the opening (32) of the mounting shell (3) faces towards the light-transmitting member (2), and an edge of the opening (32) is attached and fixed to the mirror body (1).

16. The bathroom mirror with a lighting function according to claim 15, wherein the mounting shell (3) is arranged horizontally at the upper end of the mirror body (1), and a supporting block (17) is arranged at the lower end or the side end of the mirror body (1), so that the mirror body (1) and the wall is suspended at intervals.

17. The bathroom mirror with a lighting function according to claim 16, wherein the thickness of the supporting block (17) equals to that of the mounting shell (3), so that the mirror body (1) after being hung is parallel to the wall.

18. The bathroom mirror with a lighting function according to claim 14, wherein two ends of the mounting shell (3) are each provided with a port cap (12), a protrusion (13) flushing with the ends of the mounting shell (3) is formed in a length direction of the inner wall of the mounting shell (3), a mounting hole (14) is formed on the end face of the protrusion (13) flushing with the ends of the mounting shell (3), and the port caps (12) are fixedly connected with the mounting hole (14) through the fasteners; the lighting assembly comprises a light-transmitting side plate (4) and a light source (7), a first slot (8) for accommodating the light-transmitting side plate (4) is formed on the inner wall of the opening (32) of the accommodating cavity (31), and a second slot (9) for accommodating the light source (7) is formed on the inner wall of the accommodating cavity (31) away from the light-transmitting side plate (4).

19. The bathroom mirror with a lighting function according to claim 14, wherein a supporting frame body (19) is arranged on the back of the mirror body (1) along the edge thereof.
